(19) United States
(12) Patent Application Publication
(10) Pub. No.: US 2006/0172609 A1
(43) Pub. Date: Aug. 3, 2006

(54) Power connector

(75) Inventors: Hsiung-Te Wang, Miaoli City (TW); Ke-Sheng Huang, Taipei Hsien (TW)

Correspondence Address: BIRCH STEWART KOLASCH & BIRCH, PO BOX 747, FALLS CHURCH, VA, 22040-0747, US

(73) Assignee: SINBON ELECTRONICS COMPANY LTD.

(21) Appl. No.: 11/043,979

(22) Filed: Jan. 28, 2005

(51) Int. Cl. H01R 13/64

(52) U.S. Cl. 439/680

(57) ABSTRACT

A power connector, particularly a power connector with a retrograde-against function and a blocking function for preventing a hollow portion of a terminal from being blocked, is described. The power connector has a connector and a corresponding connector, which are connected with each other. Each connector has an insulation body and an insulation case, respectively, which are integrally formed with all terminals in one piece by a molding method, respectively. Each hollow columnar connecting terminal of the connector includes plural interfering pieces and a blocking body disposed inside the hollow portion, and each solid corresponding terminal of said corresponding connector has at least an interfering piece. All these interfering pieces integrally interfere with the insulation body and the insulation case, respectively. Furthermore, the insulation body of the connector is correspondingly connected to the corresponding connector inside the insulation case, and connecting and corresponding connecting terminals are mutually connected.

### BACKGROUND OF THE INVENTION

1. Field of the Invention

The present invention is related to a power connector, and more particularly to a power connector applied between digital electronic products and a powerbank so as to make the power bank supply and charge the digital electronic products.

2. Description of Related Art

It is known that digital electronic products have already become necessities for modem people. In daily life, travel, errands, or work, the use of digital electronic products is a certainty. Examples of these include digital cameras, digital photographing equipment, MP4 digital video players, PDAs, and notebooks, which are convenient for the user.

However, for these “carrying” and “no main electricity supplied” digital electronic products, the supplying time of the battery is often a nightmare for the user, and further, because the original battery is always expensive but still has a short supplying time, the digital electronic products actually cannot be fully utilized. Therefore, a powerbank has come into use.

Reference is made to FIG. 1, which illustrates a powerbank 2 simultaneously supplying and charging a notebook 1. As shown in FIG. 1, the powerbank 2 is electrically connected to the notebook 1, firstly through a transmission line 22, and then a connector 22 at the other end of the transmission line 22. The connector 22 is electrically connected to a corresponding connector 212 on the powerbank 2 so that the notebook 1 and the powerbank 2 are electrically connected together to achieve the purpose of simultaneous power supply and charging. Furthermore, because the supplying time of the powerbank 2 is in excess of 4 to 8 hours, and the powerbank 2 can also charge the notebook 1, buying the powerbank 2 is actually better than buying several original batteries, which are expensive and have a short supplying time. The power connector 21 includes the connector 211 and the corresponding connector 212.

However, the power connector 21 still has some defects:

1. When the connector 211 and the corresponding connector 212 of the conventional power connector 21 are connected with each other, the terminals of each connector easily become loose so as to cause a retrograde movement and even defects in connection and contact.

2. Each of the terminals in the connector 211 is a female terminal having a passing-through plugging hole and the connector 211 still has to form a covering layer through injecting the plastic so that if any one of the female terminals does not have to be connected to the conduction line, it has to seal the corresponding opening for the female terminal firstly and then perform the injection. Otherwise, the opening of the female terminal will be blocked by the injected plastic, rendering the opening of the female terminal not electrically connectable. Therefore, this process is actually inconvenient and cannot be automatized.

3. Each of the terminals of the connectors 211 is formed by combining two semicircles so that a problem of fatigued elasticity easily occurs to influence the quality of electrically contact. In other words, the female and male terminals of the connector 211 do not match very well.

4. In the power connector 21, all female and male terminals of the connector 211 and of the corresponding connector 212 are mounted on an inner insulation body (not shown), and then the assembled insulation body is placed in an insulation case to form the whole power connector 21. Therefore, the assembling speed is influenced due to the complicated structure.

5. The power connector 21 does not have a function of detection and cannot conform to future demand.

### SUMMARY OF THE INVENTION

The object of the present invention is to provide a power connector, in which the connector terminal (female terminal) and the corresponding terminal (male terminal) both have a counter-retrograde design, thereby avoiding retrograde movement when connecting with each other. Further, even if any one of the terminals does not need to be wire conducted, a sealing, as seen in the conventional design, is not needed because the connector of the present invention itself already has the function of a preventing block.

Another object of the present invention is to provide a power connector, in which the connector terminal has a design of elastically accommodating the corresponding terminal. Since the accommodation is a complete covering, the problem of fatigued elasticity does not occur, and it even can provide a better contact quality and a better match between the connector and the corresponding connector.

A further object of the present invention is to provide a power connector, in which the connections between each connecting terminal and the connector and between each connecting terminal and the corresponding connector are achieved without an additional inner insulation body in the prior art so that the whole structure can be simplified and the assembling therefore can be more effective.

Yet another object of the present invention is to provide a power connector, which reserves one set of terminals for detection so as to conform to the future demand.

The power connector according to the present invention comprises a connector having plural connecting terminals and an insulation body, which is integrally formed with all said connecting terminals in one piece by a molding method. Each hollow columnar connecting terminal has plural interfering pieces formed at an outer wall thereof and a blocking body disposed inside said hollow portion, and each interfering piece integrally interferes with said insulation body. The power connector also includes a corresponding connector comprising plural connecting terminals, and an insulation case integrally formed with all said connecting terminals in one piece by molding. The insulation case has an indentation with a shape corresponding to that of said above-mentioned insulation body for mutual connection. Each solid corresponding connecting terminal includes at least an interfering piece integrally formed with said insertion portion so that each corresponding connecting terminal is correspondingly connected to said hollow portion for insertion.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the electrical connection of a conventional power connector between a notebook and a powerbank;

FIG. 2 is a three-dimensional decomposition drawing showing the power connector of the present invention;

FIG. 3 is a cross-sectional view showing the assembled power connector of the present invention;

FIG. 4 is a three-dimensional upward view showing a connecting terminal of the power connector of the present invention;

FIG. 5 is an end view showing a connecting terminal of the power connector of the present invention;

FIG. 6 is a cross-sectional view according to the 6-6 cross section of FIG. 5 of the power connector of the present invention;

FIG. 7 is a three-dimensional drawing showing a corresponding connecting terminal of the power connector of the present invention; and

FIG. 8 is a side view showing a corresponding connecting terminal of the power connector of the present invention.

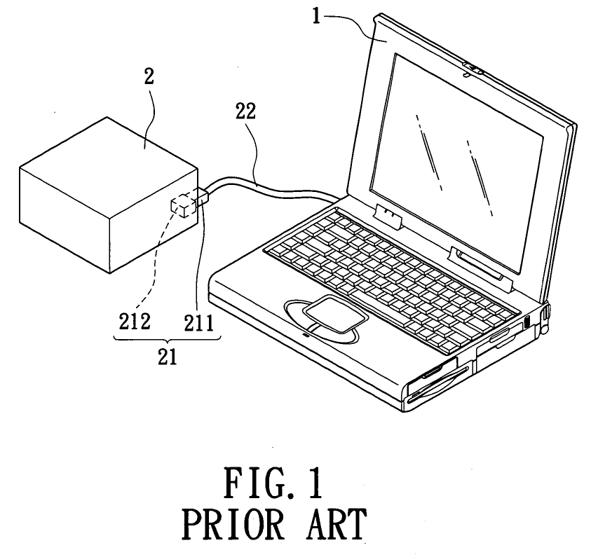

### DETAILED DESCRIPTION OF PREFERRED EMBODIMENTS

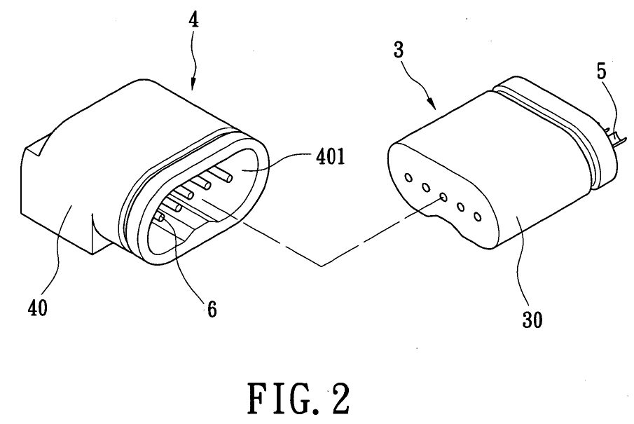

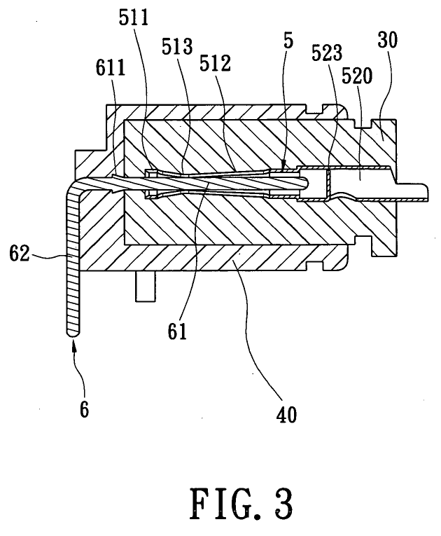

Reference is made to FIGS. 2 and 3, illustrating the power connector according to the present invention. The power connector includes a connector 3 and a corresponding connector 4 for connection with the connector 3.

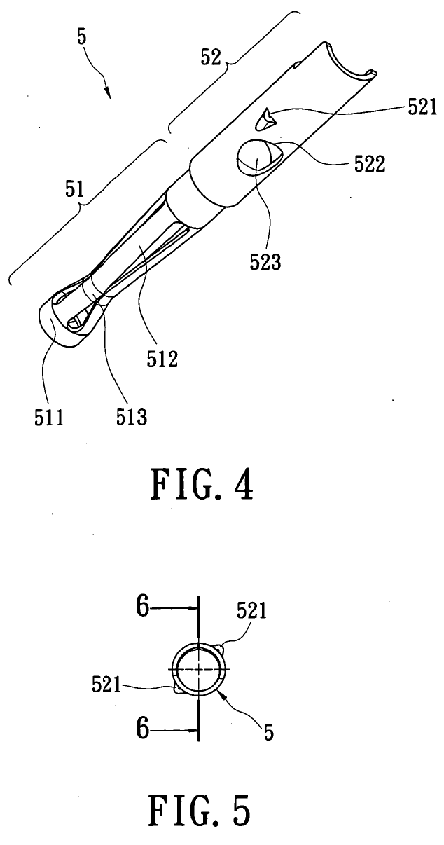

Reference is made to FIGS. 2 to 6. The connector 3 includes plural hollow connecting terminals 5 and an insulation body 30, which is integrally formed with all connecting terminals 5 in one piece by a molding method. Each hollow connecting terminal 5 includes a front section 51 and a rear section 52. The front section 51 includes plural elastic claws disposed in a circle, and all elastic claws 512 are connected to a ring portion 511 through one end thereof. The ring portion 511 is further formed in a bell shape for facilitating insertion of a solid terminal. The other ends of each of elastic claws 512 are connected to one end of the rear section 52. Furthermore, a gauge among all elastic claws 512 can be shrunk properly, thereby forming a constricting portion 513 with an elastic constriction function.

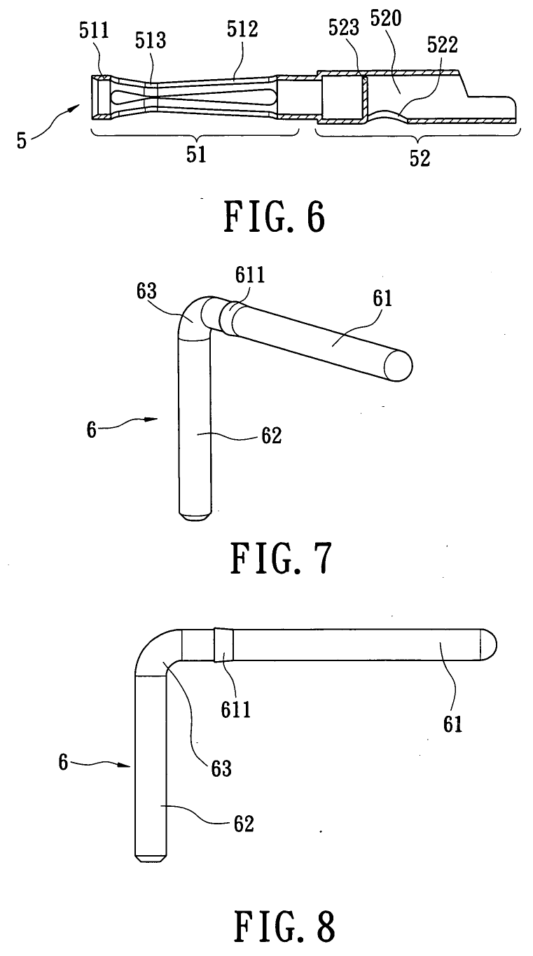

The rear section 52 includes a hollow inner space 520 (FIGS. 3 and 6), plural interfering pieces 521 formed at an outer wall of the rear section 52, an hole body 522 mounted at a suitable position of the rear section 52, and a blocking body 523 formed by the hole body 522. The hole body 522 and the blocking body 523 can be formed simultaneously through a C-shaped cutting trench in such a way that the slice blocking 523 is still connected to the edge of the hole body 522. Therefore, after the blocking body 523 is bent, it still can block in the inner space 520 of the rear section 52. Each interfering piece 521 of each connecting terminal 5 can also have a barbed shape.

The insulation body 30 of the connector 3 is integrally formed with all connecting terminals in one piece by molding, and therefore, the insulation body 30 still can interfere with each barb-shaped interfering piece 521 of each connecting terminal 5 so as to have a counter-retrograde function, and at this time, the front end and the back end of each connecting terminal 5 still communicate with the insulation body 30, respectively.

Reference is made to FIGS. 2 and 3 in conjunction with FIGS. 7 and 8. The corresponding connector 4 includes plural solid connecting terminals 6, and an insulation case 40 integrally formed with all connecting terminals 6 in one piece by molding. Furthermore, an indentation room 401 having a shape corresponding to that of the above-mentioned insulation body 30 is mounted on the insulation case 40. The insulation body 30 of the connector 3 thus can have a matched connection with the indentation room 401.

Each solid connecting terminal 6 includes, integrally formed, an insertion portion 61, an interfering piece 611 formed on the insertion portion 61, a welding portion 62, and a bent portion 63 connected between the insertion portion and the welding portion 62. The interfering piece 611 can be a barb-shaped pipe, as shown in FIGS. 7 and 8.

The insulation case 40 of the corresponding connector 4 is integrally formed with all corresponding connecting terminals 6 in one piece by molding. The insulation body 40 still thus can interfere with each barb-shaped pipe interfering piece 611 of each connecting terminal 6 so as to have a counter-retrograde function. Furthermore, the insertion portion 61 of the connecting terminal 6 is inserted into the indentation room 401 of the insulation case 40, and each welding portion 62 is exposed to the outside of the insulation case 40 for facilitating welding.

Certainly, each above-mentioned connecting terminal 6 also can have a bent portion bent in a different direction, or not have a bent portion and have the insertion portion 61 and the welding portion 62 arranged in alignment, thereby conforming to different connecting direction.

Reference is made to FIGS. 2 and 3. The connector 3 has at least five connecting terminals and the corresponding connector 4 also correspondingly has at least five corresponding connecting terminals 6 for mutually electrical connection. Therefore, the number of those terminals is larger then that in the prior art for reserving for other functions (e.g., detecting function etc.).

The connector 3 is connected with the corresponding connector 4 through a combination of the insulation body 30 into the indentation room 401 to form a tightly-fixed state therebetween so that each insertion portion 61 of the connecting terminal 6 can be inserted into the hollow portion of each connecting terminal 5.

Each connecting terminal 6 is inserted into the hollow portion through the bell-shaped ring portion 511 of the connecting terminal 5, and the constricting portion 513 of each connecting terminal 5 is elastically clamped at the insertion portion 61 of each connecting terminal 6 for achieving the electrical contact. In other words, the connector 3 and the corresponding connector 4 are electrically connected with each other, thereby transmitting the electricity of the powerbank to the digital electronic product such as, for example, a notebook, and simultaneously achieving the purpose of power supply.

In the structure of the present invention described above, since interfering pieces 521 and 611 with an integrally interfering effect are mounted between each connecting terminal 5 and the insulation body 30 of the connector 3, and between each connecting terminal 6 and the insulation case 40 of the corresponding connector 4 both, when the connector 3 and the corresponding connector 4 are connected to each other, each terminal may have a retrograde-against efficiency as being inserted.

In the connector 3, each connecting terminal 5 itself has a blocking body 523 in side the inner space 520, and thus, even though the fifth connecting terminal 5 is unoccupied and not wire conducted, when there is a need to inject a covering layer (not shown) for covering the connector 3, the fifth connecting terminal 5 need not be sealed, as required in the prior art, because the blocking body 523 of each connecting terminal 5 can prevent the hollow portion of the connecting terminal 5 from being blocked by the plastic. Therefore, a convenient, fast, easy, and automatic manufacturing process can be achieved because the process of sealing is no longer needed. Furthermore, the front end of each connecting terminal 5 has a bell-shaped ring portion 51 so as to facilitate the insertion of each connecting terminal 6.

In the connector 3, each connecting terminal 5 is a column with a complete covering, not the semicircle metal piece of the conventional connector, and therefore, the problem of fatigued elasticity does not easily occur. Further, the electrical contact thereof with the connecting terminal 6 is effected by the elastic constricting portion 513, which is a complete covering, so that a better match and a better quality of electrical contact can be achieved.

“Each connecting terminal 5 and the connector 3” and “each connecting Terminal 6 and the connector 4” are both integrally formed with all terminals 5 and 6, respectively, by molding, so that there is absolutely no need to dispose a further inner insulation body, and thus, the structure can be simplified and the assembling speed thereof can be improved.

Moreover, the power connector reserves a set of terminals (the fifth connecting terminal 5 and the fifth corresponding terminal 6) for other uses (e.g., a detecting function) so as to conform to future demand.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A power connector, comprising:
a connector having plural connecting terminals and an insulation body, the insulation body being integrally formed with all said connecting terminals in one piece by a molding method, wherein each hollow columnar connecting terminal has plural interfering pieces formed on an outer wall thereof, a hollow portion and a blocking body disposed inside said hollow portion for sealing the hollow portion, and the insulation body and each connecting terminal are interfered to each other by each interfering piece, for preventing each connecting terminal from being moved relative to the insulation body; and
a corresponding connector comprising plural connecting terminals and an insulation case, the insulation case being integrally formed with all said connecting terminals in one piece by molding, wherein said insulation case has an indentation having a shape corresponding to that of said above-mentioned insulation body for mutual connection, and each solid corresponding connecting terminal has at least an interfering piece formed on an outer wall thereof, and the insulation case and each corresponding connecting terminal are interfered to each other by each interfering piece, for preventing each corresponding connecting terminal from being moved relative to the insulation case.

2. A power connector as claimed in claim 1, wherein said blocking body of each connecting terminal of said connector is directly bent from each connecting terminal, and said bending is stopped at said hollow portion of said connecting terminal.

3. A power connector as claimed in claim 1, wherein each connecting terminal of said connector comprises a front section and a rear section, wherein said rear section comprises said interfering pieces and said blocking body, said front section comprises plural elastic claws disposed in a circle and a ring portion connected to one end of each said elastic claw, and the other ends of each of said elastic claws are connected to one end of said rear section.

4. A power connector as claimed in claim 3, wherein said ring portion of said front section of each said connecting terminal of said connector is further formed into a bell shape for facilitating insertion.

5. A power connector as claimed in claim 3, wherein among all said elastic claws of said front section of each said connecting terminal of said connector, a gauge is provided for proper shrinking, thereby forming a constricting portion.

6. A power connector as claimed in claim 1, wherein said interfering piece of each connecting terminal of said connector has a barbed shape.

7. A power connector as claimed in claim 1, wherein each said corresponding connecting terminal of said corresponding connector comprises an insertion portion and a welding portion, wherein said insertion portion has said interfering piece and is inserted into said indentation room of said insulation case, and said welding portion is exposed to an outside of said insulation case.

8. A power connector as claimed in claim 7, wherein each said corresponding connecting terminal of said corresponding connector further comprises a bent portion connected between said insertion portion and said welding portion.

9. A power connector as claimed in claim 1, wherein said interfering piece of each said corresponding connecting terminal of said corresponding connector is a barb-shaped pipe.

10. A power connector as claimed in claim 1, wherein said connector and said corresponding connector respectively have a spare connecting terminal and a spare corresponding terminal.

11. A power connector as claimed in claim 1, said blocking body being formed from a section of said hollow column connecting terminal which is removed to form a hole body.
